(19) United States
(12) Patent Application Publication
(10) Pub. No.: US 2010/0233665 A1
(43) Pub. Date: Sep. 16, 2010

(54) Daryll-eyes

(76) Inventor: Thomas Wilkinson, Stuffield, CT (US)

Correspondence Address: Thomas W. Wilkinson, 670 East Street South, Suffield, CT, 06078, US

(21) Appl. No.: 12/477,156

(22) Filed: Jun. 3, 2009

Related U.S. Application Data
(60) Provisional application No. 61/209,776, filed on Mar. 12, 2009.

(51) Int. Cl. G09B 19/00

(52) U.S. Cl. 434/250

(57) ABSTRACT

A dance training aid ‘Daryll-eyes’, for general use is disclosed to be fabricated such that it rests on the head of the user. The frame is supported by the nose and ears. The device blocks the vision of the wearer in the downward direction.

### CROSS REFERENCE TO RELATED APPLICATIONS

Provisional Patent Application: U.S. 61/209,776; Filing Receipt Confirmation No: 9974

### STATEMENT OF FEDERALLY SPONSORED RESEARCH/DEVELOPMENT (IF ANY)

none

### SEQUENCE LISTING

none

### BACKGROUND OF THE INVENTION

The ‘Daryll-Eyes’ is a new design for an invention to assist a beginning ballroom dance student from looking at their feet when learning how to dance. The invention attaches to the student's head. When someone with no prior dance experience begins to take lessons they always have to look at their feet, this is normal. With learning unfamiliar foot sequences we must initially look where we are placing our feet. But after a certain number of hours of instruction, and this varies with each person, there comes a time when they need to stop looking downwards and begin to attain a more pleasing shape for the onlookers.

A more advanced ballroom dancer very rarely looks in the direction of their feet while dancing and often times their head position is in a slightly upwards position. This is not the normal position for any person's head during a normal day and consequently this ‘upward position’ needs to be learned through teaching and repetition. When first learning how to dance a ‘bad’ habit can be formed by always looking down at ones feet.

Most professional dance teachers will tell you, that “once you learn how to dance by looking at your feet, subsequently we will have to re-teach you how to dance Without' looking at your feet.”¹ 1-Gunnar Sverisson & partner/wife Daryll—owners of Ballroom Fever Dance Studio, Enfield Conn. 2007 Ohio Star Ball American Style 9-Dance Champions

### Champions—Constitution State Challenge 2007 Open Pro American Smooth

### Champions—USA NATIONAL 2007 Open Pro American Style 9-Dance

or Looking down at your feet while dancing is like staring at the bonnet of your car while driving, says Anton du Beke. “You need to look where you're going. Plus, your head is heavy and plays a vital role in counterbalancing the rest of your body. Looking down will ruin your shape, posture and balance.”² 2-Best known to the public as professional dancers on the hit BBC TV program Strictly Come Dancing, Anton Du Beke and Erin Boag first made their names in the highly competitive world of international dance competitions as both amateurs and professionals, winning many highly prestigious titles.

### BRIEF SUMMARY OF THE INVENTION

The ‘Daryll-Eyes’ has two arms similar to a normal pair of glasses which extend backwards along the side of the head and rest on top of the ears (FIG. 3). The front part of the invention has a nose rest. There are no rims going above or completely around the eyes. There are pieces of material traveling from the nose area outwards, under each eye, across the cheeks to the temple areas. There are pieces of material from the temple areas traveling back along both sides of the head and resting on the ears. The material which travels under the eyes, along each cheek area, extends downwards beneath each individual eye, which restricts the viewing of objects below a certain level.

### BRIEF DESCRIPTION OF THE DRAWINGS

FIG. 1: Top view, looking at the invention from the top. Item ‘A’ indicates location of a hinge which would permit the glasses to fold for non use.

FIG. 2: Front view, looking at the invention frontally as if it were being worn by a dancer. Item ‘B’ indicates the relative position of the user's eye.

FIG. 3: Side view, looking at the side of the device, as through one were looking at one of the ears of the dancer. Item ‘C’ indicates the material which rests on the uses's nose. Item ‘D’ indicates the relative position of the user's eye position. Item ‘E’ indicates the material below the eye which blocks or inhibits the vision of the user in the downward direction.

### DETAILED DESCRIPTION OF THE INVENTION

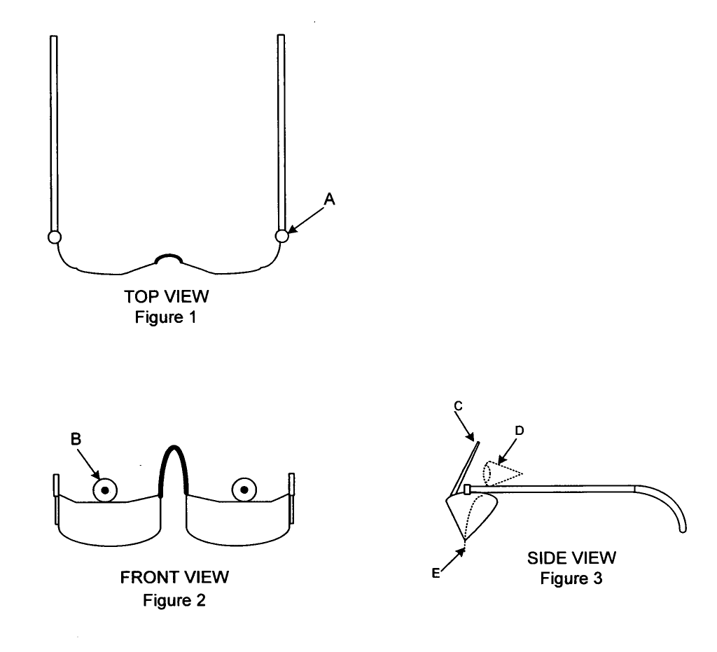

Refer to FIGS. 1, 2 and 3. The overall size of Daryll-eyes is not unlike a regular pair of glasses. Opaque pieces of material (E) which extend downwards from eye level block the sight of the person if one, while keeping their head level, were to attempt to rotate their eyes (B+D) to look in a downward direction. Even if the person does attempt to look at their feet while wearing Daryll-Eyes they would have to bend their head so far forward they would not be able to dance at all. The Daryll-Eyes could be attached to the head by an elastic strap extending around the rear of the head or like a normal pair of glasses, resting on the ears and the nose (C).

Daryll-Eyes could be made out of any material, but plastic would be the most suitable and probably as it should be made with a Z87 rating for safety purposes.

The material under each eye could be sandblasted to obstruct viewing or in some other manner be fabricated so as to-inhibit clear vision through to ones feet.

A hinge (A) could be provided to permit the folding of the invention.

Thus having described the daryll-eyes, what I claim as new is:

1. The Daryll-Eyes blocks or inhibits the vision of both eyes of a dancer in the downward direction.
